(19) United States
(12) Patent Application Publication
(10) Pub. No.: US 2025/0158141 A1
(43) Pub. Date: May 15, 2025

(54) BATTERY PACK FOR SUPPLYING ELECTRIC POWER TO A POWER TOOL

(71) Applicant: Nanjing Chervon Industry Co., Ltd., Nanjing (CN)

(72) Inventor: Guofang Xu, Nanjing (CN)

(21) Appl. No.: 19/023,668

(22) Filed: Jan. 16, 2025

Related U.S. Application Data
(63) Continuation of application No. PCT/CN2023/107735, filed on Jul. 17, 2023.

(30) Foreign Application Priority Data
Aug. 16, 2022 (CN) 202210978051.6

(51) Int. Cl. H01M 10/42; H01M 4/58; H01M 50/213; H01M 50/247; H01M 50/296; H01M 50/51

(52) U.S. Cl. CPC H01M 10/425; H01M 4/5825; H01M 50/213; H01M 50/247; H01M 50/296; H01M 50/51; H01M 2220/30

(57) ABSTRACT

A battery pack for supplying electric power to a power tool includes a housing, at least one first battery cell disposed in the housing and supported by the housing, at least one second battery cell disposed in the housing and supported by the housing, and a terminal assembly electrically connected to the at least one first battery cell and the at least one second battery cell to transmit electric power from the at least one first battery cell and the at least one second battery cell to the power tool. A first battery cell has a first capacity and a first cycle life, a second battery cell has a second capacity and a second cycle life, the first cycle life is greater than the second cycle life, and the first capacity is less than the second capacity.

### RELATED APPLICATION INFORMATION

This application is a continuation of International Application Number PCT/CN2023/107735, filed on Jul. 17, 2023, through which this application also claims the benefit under 35 U.S.C. § 119 (a) of Chinese Patent Application No. 202210978051.6, filed on Aug. 16, 2022, which applications are incorporated herein by reference in their entireties.

### TECHNICAL FIELD

The present application relates to an energy storage device and, in particular, to a battery pack for supplying electric power to a power tool.

### BACKGROUND

With the development of battery technology, engine tools are gradually replaced with power tools. In order that a cordless power tool has a better use effect, a battery pack is required to have higher output characteristics. For example, to achieve a working effect and a service life similar to those of an engine tool, increasingly higher requirements are placed on the performance of the battery pack, such as the power density, energy density, and service life.

### SUMMARY

A battery pack for supplying electric power to a power tool includes a housing; at least one first battery cell disposed in the housing and supported by the housing, where the first battery cell has a first capacity and a first cycle life; at least one second battery cell disposed in the housing and supported by the housing, where the second battery cell has a second capacity and a second cycle life, the first cycle life is greater than the second cycle life, and the first capacity is less than the second capacity; and a terminal assembly electrically connected to the first battery cell and the second battery cell to transmit electric power from the first battery cell and the second battery cell to the power tool.

A battery pack for supplying electric power to a power tool includes a housing detachably mounted to the power tool; at least one first battery cell disposed in the housing and supported by the housing, where the first battery cell has a first power density; at least one second battery cell disposed in the housing and supported by the housing, where the second battery cell has a second power density, and the ratio of the second power density to the first power density is greater than or equal to 2; and a terminal assembly electrically connected to the first battery cell and the second battery cell to transmit electric power from the first battery cell and the second battery cell to the power tool.

A battery pack for supplying electric power to a power tool includes a housing detachably mounted to the power tool; at least one first battery cell disposed in the housing and supported by the housing, where the first battery cell has a first energy density; at least one second battery cell disposed in the housing and supported by the housing, where the second battery cell has a second energy density, and the ratio of the second energy density to the first energy density is greater than or equal to 1.5; and a terminal assembly electrically connected to the first battery cell and the second battery cell to transmit electric power from the first battery cell and the second battery cell to the power tool.

A battery pack for supplying electric power to a power tool includes a housing; at least one first battery cell disposed in the housing and supported by the housing, where the first battery cell is a capacitor cell; at least one second battery cell disposed in the housing and supported by the housing, where the chemical property of the second battery cell is different from the chemical property of the first battery cell; and a terminal assembly electrically connected to the first battery cell and the second battery cell to transmit electric power from the first battery cell and the second battery cell to the power tool.

A battery pack for supplying electric power to a power tool includes a housing; multiple first battery cells disposed in the housing and supported by the housing, where the first battery cell is a sodium-ion cell; multiple second battery cells disposed in the housing and supported by the housing, where the chemical property of the second battery cell is different from the chemical property of the first battery cell; and a terminal assembly electrically connected to the first battery cell and the second battery cell to transmit electric power from the first battery cell and the second battery cell to the power tool.

A battery pack for supplying electric power to a power tool includes a housing; multiple first battery cells disposed in the housing and supported by the housing, where the first battery cell is a lithium iron phosphate cell; multiple second battery cells disposed in the housing and supported by the housing, where the chemical property of the second battery cell is different from the chemical property of the first battery cell, and the minimum distance between the second battery cell and the first battery cell is greater than or equal to 1 mm; and a terminal assembly electrically connected to the first battery cell and the second battery cell to transmit electric power from the first battery cell and the second battery cell to the power tool.

A battery pack for supplying electric power to a power tool includes a housing detachably mounted to the power tool; at least one first battery cell disposed in the housing and supported by the housing, where the first battery cell has a first capacity; at least one second battery cell disposed in the housing and supported by the housing, where the second battery cell has a second capacity, and the first capacity is less than the second capacity; and a terminal assembly electrically connected to the first battery cell and the second battery cell to transmit electric power from the first battery cell and the second battery cell to the power tool. The battery pack further includes a controller configured to cut off the power supply of the second battery cell according to a working parameter of the first battery cell.

A battery pack for supplying electric power to a power tool includes a housing detachably mounted to the power tool; a first branch including multiple first battery cells disposed in the housing and supported by the housing; a second branch including multiple second battery cells disposed in the housing and supported by the housing, where the first battery cell is different from the second battery cell in at least one working characteristic parameter; and a terminal assembly electrically connected to the first branch and the second branch to transmit electric power from the multiple first battery cells and the multiple second battery cells to the power tool. The first branch further includes a first switching circuit, and the second branch further includes a second switching circuit. The battery pack further includes a controller configured to control the opening and closing of the first switching circuit and the second switching circuit according to working characteristic parameters.

A battery pack for supplying electric power to a power tool includes a housing; at least one first battery cell disposed in the housing and supported by the housing, where the electrolyte of the first battery cell is liquid; at least one second battery cell disposed in the housing and supported by the housing, where the electrolyte of the second battery cell is solid; and a terminal assembly electrically connected to the first battery cell and the second battery cell to transmit electrical energy from the first battery cell and the second battery cell to the power tool. The power density of the first battery cell is greater than the power density of the second battery cell, and the energy density of the second battery cell is greater than the energy density of the first battery cell.

### BRIEF DESCRIPTION OF THE DRAWINGS

FIG. 1 is a perspective view of a battery pack in an example.

FIG. 2A is a schematic diagram illustrating the electrical connection between battery cells in an example.

FIG. 2B is a schematic diagram illustrating the electrical connection between battery cells in an example.

FIG. 2C is a schematic diagram illustrating the electrical connection between battery cells in an example.

FIG. 3A is a schematic diagram illustrating the battery cell discharge with a voltage plateau in an example.

FIG. 3B is a schematic diagram illustrating the battery cell discharge without a voltage plateau in an example.

FIG. 4 is a schematic diagram illustrating battery branch control in an example.

FIG. 5A is a schematic diagram illustrating the arrangement of battery cells in an example.

FIG. 5B is a schematic diagram illustrating the arrangement of battery cells in an example.

FIG. 5C is a schematic diagram illustrating the arrangement of battery cells in an example.

FIG. 5D is a schematic diagram illustrating the arrangement of battery cells in an example.

### DETAILED DESCRIPTION

The present application is described below in detail in conjunction with drawings and examples.

It is to be understood by those skilled in the art that in the description of the present application, orientations or position relations indicated by terms such as “up”, “down”, “front”, “rear”, “left”, and “right” are based on the drawings. These orientations or position relations are intended only to facilitate and simplify the description of the present application and not to indicate or imply that a device or element referred to must have such particular orientations or must be configured or operated in such particular orientations. Thus, the terms are not to be construed as limiting the present application.

The present application is described below in detail in conjunction with drawings and examples.

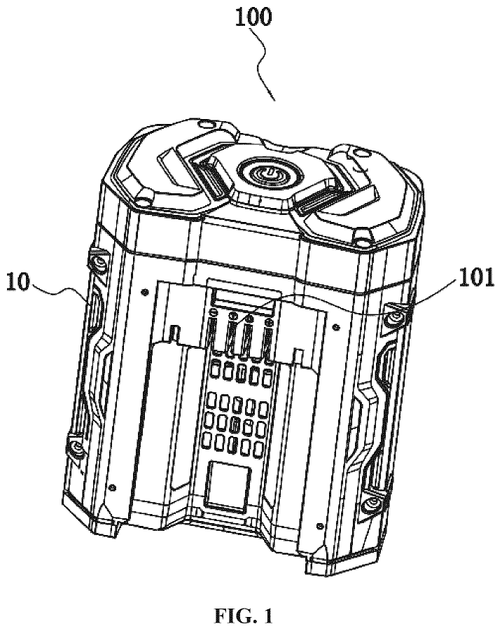

A battery pack 100 shown in FIG. 1 is an energy storage device capable of storing electrical energy to supply power to an electronic device. In this example, the electronic device may include a large-sized outdoor traveling device such as a riding mower or a snow thrower. Alternatively, the electronic device may include some energy conversion devices, such as an adapter or an inverter, capable of converting the electrical energy outputted by the battery pack 100 to supply power to other small-sized power tools such as handheld power tools and supply power to some household electrical devices such as a lamp, a mosquito killer, a fan, a mobile phone, a computer, and other electrical devices in daily life. The present application does not limit the shape of the battery pack 100. The battery pack 100 may be in the shape shown in FIG. 1 or may be a rectangular parallelepiped, a cylinder, or another three-dimensional structure.

In this example, the battery pack 100 has a housing 10, a terminal assembly 101 is provided on the housing 10 and can be connected to terminals on a power tool, a charger, or an adapter so that the electrical energy stored in the battery pack 100 can be outputted to the power tool, or the battery pack 100 can be charged using the charger. In this example, the terminal assembly may include a positive terminal, a negative terminal, and a communication terminal. In this example, the terminal assembly 101 is electrically connected to the battery cells in the battery pack 100 so that the electric power stored in the battery cells can be transmitted to the power tool connected to the battery cells, or the charger can transmit the electric power to the battery cells to charge the battery cells. In this example, one battery cell may include one battery core.

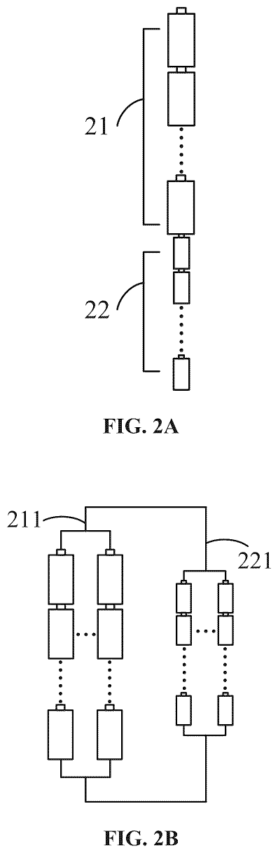

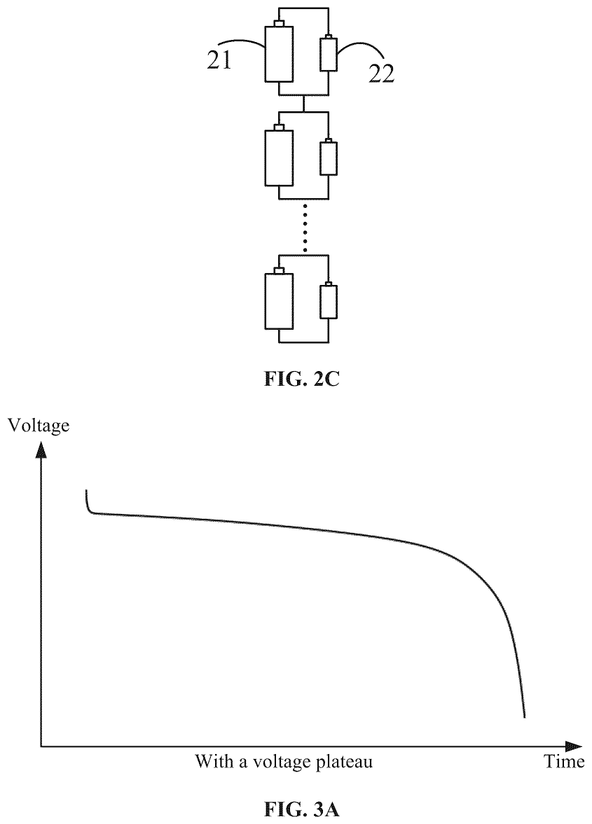

In this example, the battery cells in the battery pack 100 may include at least first battery cells 21 and second battery cells 22. In an optional example, as shown in FIG. 2A, the first battery cells 21 and the second battery cells 22 may be connected in series. In an optional example, as shown in FIG. 2B, the first battery cells 21 are connected in series to form a first branch 211, the second battery cells 22 are connected in series to form a second branch 221, and the first branch 211 and the second branch 221 are connected in parallel. In an optional example, as shown in FIG. 2C, the first battery cell 21 and the second battery cell 22 may be connected in parallel and then connected in series with the first battery cell 21 and the second battery cell 22 connected in parallel. In this example, other types of electrical connection manners may exist between the two types of battery cells and are not listed here one by one.

In this example, the first battery cell 21 and the second battery cell 22 may be two completely different battery cells or two battery cells with some same characteristics. For example, the first battery cell 21 may have a first capacity and a first cycle life, and the second battery cell 22 may have a second capacity and a second cycle life. The so-called cycle life may be the number of charge and discharge cycles that the battery cell can perform while maintaining a certain output capacity and may also be referred to as the service life of the battery. The first capacity is different from the second capacity, and the first cycle life is different from the second cycle life. In this example, the first cycle life is greater than the second cycle life, and the first capacity is less than the second capacity.

In this example, the ratio of the first cycle life to the second cycle life is greater than or equal to 2, and the ratio of the first capacity to the second capacity is less than or equal to 0.8. That is to say, the first battery cell 21 has the characteristics of a longer service life but a smaller capacity, and the second battery cell 22 has a shorter service life but a larger capacity. In an example, the first battery cell 21 may be a lithium iron phosphate cell, and the second battery cell 22 may be a ternary lithium cell.

In this example, when the battery pack 100 is formed by the second battery cells 22 and the first battery cells 21, certain requirements are placed on the actual quantity of electric charge of the two types of battery cells. For example, the difference between the actual quantity of electric charge of the second battery cell 22 and the actual quantity of electric charge of the first battery cell 21 is greater than zero and less than or equal to the difference between the rated capacity of the second battery cell 22 and the rated capacity of the first battery cell 21. The rated capacity refers to the quantity of electric charge of the fully charged battery cell, and the unit of the rated capacity is Ah or mAh. In an example, the difference between the actual quantity of electric charge of the second battery cell 22 and the actual quantity of electric charge of the first battery cell 21 is greater than zero and less than or equal to half of the difference between the rated capacity of the second battery cell 22 and the rated capacity of the first battery cell 21. In an example, when the battery pack is assembled using the two types of battery cells, the actual quantity of electric charge of the second battery cell 22 is greater than zero, and the actual quantity of electric charge of the first battery cell 21 is greater than zero. In an example, when the battery pack is assembled using the two types of battery cells and the actual quantity of electric charge of the first battery cell 21 is the rated capacity, the actual quantity of electric charge of the second battery cell 22 is greater than the rated capacity of the first battery cell 21.

An actual quantity of electric charge difference exists between the first battery cell 21 and the second battery cell 22 during installation, and the quantities of electric charge of the two battery cells change synchronously during the discharging process or the charging process of the battery pack 100. Therefore, a mapping relationship exists between the capacity of the second battery cell 22 and the capacity of the first battery cell 21, and a controller 23 may calculate the state of charge (SoC) of the first battery cell 21 according to the SoC of the second battery cell 22. For example, when two battery cells are discharged in series, the change in the SoC of the first battery cell and the change in the SoC of the second battery cell are consistent, that is, ΔSoC of the first battery cell and ΔSoC of the second battery cell are consistent so that according to the SoC of one battery cell, the SoC of the other battery cell can be obtained through mapping. For example, at the beginning of discharging, the SoC of the first battery cell 21 is SoC1, and the SoC of the second battery cell 22 is SoC2. If the SoC of the second battery cell 22 at any discharge moment during the discharging process can be obtained, ΔSoC, the change in the SoC of the second battery cell 22, can be calculated. Since the first battery cell 21 and the second battery cell 22 have the same ΔSoC during the discharging process, the SoC of the first battery cell 21 at this moment may be obtained as SoC1-ΔSoC.

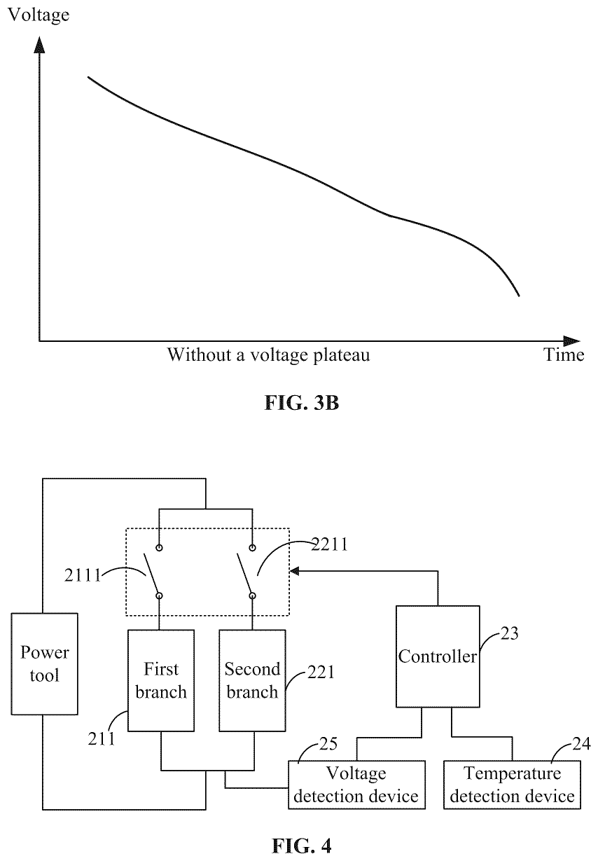

During the discharging process of the battery pack 100, the first battery cell 21 has a discharge voltage plateau as shown in FIG. 3A, and the second battery cell 22 does not have a discharge voltage plateau as shown in FIG. 3B. That is to say, during the discharging process of the battery pack, the discharge voltage of the first battery cell 21 remains almost unchanged, while the discharge voltage of the second battery cell 22 changes significantly. Therefore, the SoC or ΔSoC of the second battery cell 22 can be determined according to the change in voltage during the discharging process of the second battery cell 22 so that the SoC of the first battery cell can be determined.

In this example, the second battery cell 22 may not be fully charged during the charging process or may not be fully discharged during the discharging process. Specifically, when the discharge of the battery pack 100 is completed, the remaining power of the second battery cell 22 is greater than or equal to 30% of the full power; or when the charge of the battery pack 100 is completed, the power of the second battery cell 22 is less than or equal to 90% of the full power. By shallowly charging and discharging the second battery cell 22 during the charging and discharging process, the service life of the second battery cell 22 can be effectively extended so that the cycle life of the second battery cell 22 and the cycle life of the first battery cell 21 are basically the same, thereby extending the service life of the entire battery pack 100.

In an example, as shown in FIG. 4, the battery pack 100 may further include the controller 23 and some parameter detection devices, such as a current detection device, a temperature detection device 24, or a voltage detection device 25. The controller 23 can acquire the parameters detected by the parameter detection devices and control the charging and discharging states of the first battery cell 21 and the second battery cell 22 accordingly.

In an example, the controller 23 may detect the temperature of the first battery cell 21 or the second battery cell 22, the ambient temperature of the battery pack 100, or the temperature inside the battery pack 100 through the temperature detection device 24.

Specifically, as shown in FIG. 4, a first switching circuit 2111 is provided between the terminal assembly 101 and the first branch 211, a second switching circuit 2211 is provided between the second branch 221 and the terminal assembly 101, and the controller 23 can control the on and off states of the first switching circuit 2111 and the second switching circuit 2211. That is to say, the controller 23 can control the charging and discharging states of the first branch 211 and the second branch 221. For example, the controller 23 can just control the first branch 211 to perform discharging or charging, just control the second branch 221 to perform charging or discharging, or control the two branches to perform charging or discharging simultaneously. The first switching circuit 2111 and the second switching circuit 2211 may be controllable switches such as power switching elements or semiconductor switching elements.

In an example, the first battery cell 21 may have a first power density, and the second battery cell 22 may have a second power density. The ratio of the second power density to the first power density is greater than or equal to 2. In this example, the first battery cell 21 may be a ternary lithium cell or a liquid electrolyte cell, and the second battery cell 22 may be a capacitor cell, a sodium-ion cell, a solid-state cell, or the like. In this example, the discharge rate of the second battery cell 22 is greater than or equal to 5 C. During the discharging process of the battery pack 100, the controller 23 may select battery cells for power supply according to tool parameters of the power tool or the working condition of the tool. For example, when the battery pack 100 acquires the communication data of the power tool through the terminal assembly 101 and determines that the power tool needs to operate at high power, the controller 23 may control the second switching circuit 2211 to be turned on and control the first switching circuit 2111 to be turned off so that the second branch 221 performs discharging. That is, when the battery pack needs to be discharged at high power, the second battery cell 22 with a high power density may be preferentially used for discharging. The high-power discharge is related to the rated voltage of the battery pack. Under different rated voltages, the discharge power that the battery pack can withstand varies. For example, when the rated voltage of the battery pack is 56 V, the output power of the battery pack is greater than or equal to 1000 W, which may be regarded as a high-power output. When the rated voltage of the battery pack is 20 V, the output power of the battery pack is greater than or equal to 300 W, which may be regarded as a high-power output.

In this example, the temperature characteristics of the second battery cell 22 are good, while the temperature characteristics of the first battery cell 21 are poor. The temperature characteristics may include the lowest temperature at which the battery cell can operate normally, the temperature range in which the battery cell can operate normally, or the like. For example, the operating temperature range of the second battery cell 22 may be −40° C. to 80° C., and the operating temperature range of the first battery cell 21 may be −20° C. to 55° C. In this example, the temperature detection device 24 may detect the ambient temperature of the operating battery pack 100. The ambient temperature of the operating battery pack 100 may specifically include the surface temperature of the components in the battery pack, the temperature of the components, or the temperature of the battery cells. The controller 23 may control the opening and closing of the first switching circuit 2111 or the second switching circuit 2211 according to the temperature detected by the temperature detection device 24. For example, when the temperature is within a preset temperature range, the controller 23 may control the second switching circuit 2211 to be turned on and control the first switching circuit 2111 to be turned off so that the second branch 221 performs discharging. The preset temperature range may be −40° C. to 0° C. That is to say, when the temperature of the battery pack 100 is relatively low, the controller 23 may select the second battery cells 22 with good low-temperature characteristics to supply power. In this example, the second battery cells 22 generate heat during the discharging process in a low-temperature environment, and the heat can preheat the first battery cells 21 with poor low-temperature characteristics. When the controller 23 detects that the temperature is higher than the preset temperature range, the controller 23 may control the first switching circuit 2111 to be turned on so that the battery pack 100 can be powered by the two types of battery cells simultaneously.

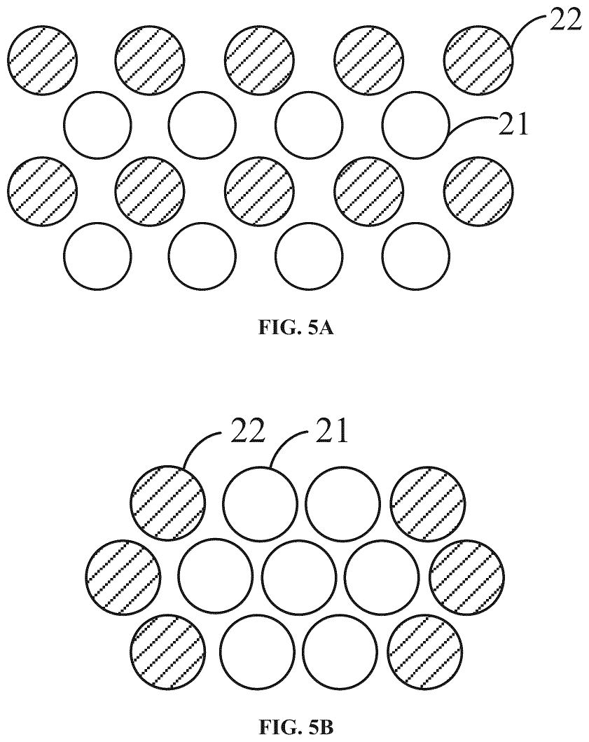

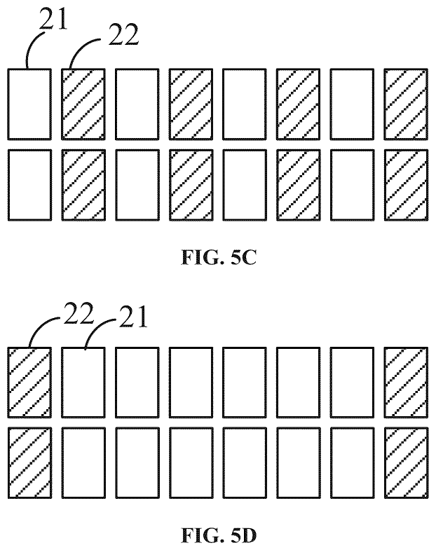

To obtain a better preheating effect, as shown in FIGS. 5A to 5D, the first battery cells 21 and the second battery cells 22 in the battery pack 100 may be arranged alternately as shown in FIGS. 5A and 5C or in a manner in which the second battery cells 22 surround the first battery cells 21 as shown in FIGS. 5B and 5D. The surrounding arrangement may be that the second battery cells 22 surround the first battery cells 21, thereby ensuring that the heat released by the second battery cells 22 can preheat the first battery cells 21 more efficiently. In this example, the arrangement of the battery cells is related to the shape of the battery cells. For example, when the battery cells are cylindrical, the alternate arrangement and the surrounding arrangement may be used as shown in FIGS. 5A and 5B; and when the battery cells are square, the alternate arrangement and the surrounding arrangement are shown in FIGS. 5C and 5D. In an example, when the two types of battery cells are arranged alternately, the ratio of the number of second battery cells 22 to the number of first battery cells 21 is greater than or equal to 0.8 and less than or equal to 1; and when the two types of battery cells are arranged in a surrounding manner, the ratio of the number of second battery cells 22 to the number of first battery cells 21 is greater than or equal to 0.6 and less than 1.

In an optional example, the two types of battery cells may have an alternate arrangement, a surrounding arrangement, or other arrangements that are not performed for preheating reasons and can reduce the overall volume of the battery pack.

In an example, the first battery cell 21 may have a first energy density, the second battery cell 22 may have a second energy density, and the ratio of the second energy density to the first energy density is greater than or equal to 1.5. That is to say, the second battery cell 22 has a characteristic of a high energy density. In an optional example, the second battery cell 22 may be a ternary lithium cell, a lithium iron phosphate cell, a sodium-ion cell, or another cell with a high energy density. In this example, the first battery cell 21 and the second battery cell 22 may be connected in parallel or series.

In an example, the first battery cell 21 is a capacitor cell, and the chemical property of the second battery cell 22 is different from the chemical property of the first battery cell 21. In an example, the second battery cell 22 may be a lithium cell. In this example, the discharge rate of the second battery cell 22 is less than or equal to 5 C. During the discharging process of the battery pack 100, the controller 23 may select battery cells for power supply according to tool parameters of the power tool or the working condition of the tool. For example, when the battery pack 100 acquires the communication data of the power tool through the terminal assembly 101 and determines that the power tool needs to operate at a high current, the controller 23 may control the first switching circuit 2111 to be turned on and control the second switching circuit 2211 to be turned off so that the first branch 211 performs discharging. That is, when the battery pack needs to be discharged at a high current, the capacitor cell may be preferentially used for discharging.

In an example, the first battery cell 21 is a sodium-ion cell, and the chemical property of the second battery cell 22 is different from the chemical property of the first battery cell 21. In an optional example, the number of first battery cells 21 is greater than the number of second battery cells 22. In an example, the second battery cell 22 may be a ternary lithium cell. In this example, the temperature detection device 24 may detect the temperature of the battery pack, and when the temperature is within the preset temperature range, the controller 23 may control the first switching circuit 2111 to be turned on and control the second switching circuit 2211 to be turned off so that the first branch 211 performs discharging. The preset temperature range may be −40° C. to 0° C. That is to say, when the temperature of the battery pack 100 is relatively low, the controller 23 may select the sodium-ion cells with good low-temperature characteristics for discharging.

In an example, the first battery cell 21 is a lithium iron phosphate cell, and the chemical property of the second battery cell 22 is different from the chemical property of the first battery cell 21. In an optional example, the second battery cell 22 is a ternary lithium cell. The first battery cell 21 and the second battery cell 22 may be connected in parallel or series, or the branches each of which is formed by the parallel connection of the first battery cell 21 and the second battery cell 22 are connected in series. In an optional example, the number of first battery cells 21 is greater than the number of second battery cells 22. In this example, the first battery cell 21 and the second battery cell 22 have the same dimensions. For example, the first battery cell 21 and the second battery cell 22 may be cylindrical cells with the same height and diameter. In this example, the two types of battery cells may be arranged in a surrounding manner, alternately, in any other manner that can reduce the overall volume of the battery pack, in any other manner that is conducive to heat dissipation, or in any other manner that is conducive to preheating between cells. In this example, the minimum distance between the first battery cell 21 and the second battery cell 22 is greater than or equal to 1 mm, that is to say, the two types of battery cells are not adjacent to each other, and the minimum distance of 1 mm exists between the two types of battery cells.

In an example, the first capacity of the first battery cell 21 is less than the second capacity of the second battery cell 22, and the controller 23 may cut off the power supply of the second battery cell 22 according to the working parameter of the first battery cell 21. In this example, the first battery cell 21 and the second battery cell 22 are connected in series. For example, a mapping relationship exists between the SoC of the second battery cell 22 and the SoC of the first battery cell 21. The controller 23 may calculate the SoC of the first battery cell 21 according to the SoC of the second battery cell 22 and when the SoC of the first battery cell 21 is less than a set value, further control the second battery cell 22 to stop being discharged. In this example, the capacity of the second battery cell 22 is larger. If whether to cut off the power supply of the second battery cell 22 is determined directly using the SoC of the second battery cell 22, the small-capacity cell may be over-discharged. If whether to cut off the power supply of the second battery cell 22 is controlled according to the SoC of the small-capacity battery cell, that is, the SoC of the first battery cell 21, the small-capacity battery cell in the battery pack can be prevented from being over-discharged. In an optional example, the battery pack 100 may further include the voltage detection device 25 that can detect the voltage of the second battery cell 22. The controller 23 may calculate the SoC of the first battery cell 21 according to the voltage of the second battery cell 22.

In an example, the first battery cell 21 and the second battery cell 22 in the battery pack 100 have different working characteristic parameters, and the controller 23 may control the opening and closing of the first switching circuit 2111 and the second switching circuit 2211 according to the preceding working characteristic parameters. The preceding working characteristic parameter may include the SoC, discharge power, discharge voltage, minimum operating temperature, maximum discharge rate, or the like of each of the two types of battery cells. In an example, the electrolyte of the first battery cell 21 may be solid, and the electrolyte of the second battery cell 22 may be liquid. In an optional example, the working characteristic parameter is the maximum discharge rate. If the maximum discharge rate of the first battery cell 21 is less than the maximum discharge rate of the second battery cell 22, when the controller 23 detects that the discharge current required by the tool is greater than or equal to a preset current threshold, the controller 23 may control the second switching circuit 2211 to be turned on and control the first switching circuit 2111 to be turned off so that the second branch 221 can be used for discharging. In an optional example, the working characteristic parameter is the minimum operating temperature. If the minimum operating temperature of the first battery cell 21 is greater than the minimum operating temperature of the second battery cell 22, when the controller 23 detects that the ambient temperature is within the preset temperature range, the controller 23 may control the second switching circuit 2211 to be turned on and control the first switching circuit 2111 to be turned off so that the second branch 221 can be used for discharging. In an optional example, the operating characteristic parameter is the SoC. When the battery pack 100 is connected to a charger for charging, the controller 23 may control the opening and closing of the first switching circuit 2111 and the second switching circuit 2211 according to the SoC, thereby performing charge equalization on the first branch 211 and the second branch 221.

In an example, the electrolyte of the first battery cell 21 is liquid, and the electrolyte of the second battery cell 22 is solid. Moreover, the power density of the first battery cell 21 is greater than the power density of the second battery cell 22, and the energy density of the first battery cell 21 is greater than the energy density of the second battery cell 22. In this example, the power density of the first battery cell 21 is greater than or equal to 250 W/kg. In this example, the energy density of the second battery cell 22 is greater than or equal to 400 Wh/kg.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A battery pack for supplying electric power to a power tool, comprising:
a housing;
a first battery cell disposed in the housing and supported by the housing, wherein the first battery cell has a first capacity and a first cycle life;
a second battery cell disposed in the housing and supported by the housing, wherein the second battery cell has a second capacity and a second cycle life, the first cycle life is greater than the second cycle life, and the first capacity is less than the second capacity; and
a terminal assembly electrically connected to the first battery cell and the second battery cell to transmit electric power from the first battery cell and the second battery cell to the power tool.

2. The battery pack of claim 1, wherein the first battery cell and the second battery cell are connected in series.

3. The battery pack of claim 1, wherein a ratio of the first cycle life to the second cycle life is greater than or equal to 2.

4. The battery pack of claim 1, wherein a ratio of the first capacity to the second capacity is less than or equal to 0.8.

5. The battery pack of claim 1, wherein during a discharging process of the battery pack, the first battery cell has a discharge voltage plateau, and the second battery cell does not have a discharge voltage plateau.

6. The battery pack of claim 1, further comprising a controller configured to calculate a state of charge (SoC) of the first battery cell according to an SoC of the second battery cell.

7. The battery pack of claim 1, wherein, when the battery pack stops being charged, an SoC of the second battery cell is less than or equal to 90%.

8. The battery pack of claim 1, wherein, when the battery pack stops discharging, an SoC of the second battery cell is greater than or equal to 30%.

9. The battery pack of claim 1, wherein the first battery cell is a lithium iron phosphate cell.

10. A battery pack for supplying electric power to a power tool, comprising:
a housing detachably mounted to the power tool;
a first battery cell disposed in the housing and supported by the housing, wherein the first battery cell has a first power density;
a second battery cell disposed in the housing and supported by the housing, wherein the second battery cell has a second power density, and a ratio of the second power density to the first power density is greater than or equal to 2; and
a terminal assembly electrically connected to the first battery cell and the second battery cell to transmit electric power from the first battery cell and the second battery cell to the power tool.

11. The battery pack of claim 10, wherein a discharge rate of the second battery cell is greater than or equal to 5 C.

12. The battery pack of claim 10, wherein the first battery cell and the second battery cell are connected in parallel.

13. The battery pack of claim 10, wherein the first battery cell forms a part of first branch, the second battery cell forms a part of a second branch, and the first branch and the second branch are connected in parallel.

14. The battery pack of claim 10, wherein a first switching circuit is provided between the terminal assembly and the first battery cell, a second switching circuit is provided between the terminal assembly and the second battery cell, and the battery pack further comprises a controller for at least controlling opening and closing of the first switching circuit and the second switching circuit.

15. The battery pack of claim 14, wherein the controller is configured to control the second switching circuit to be turned on and control the first switching circuit to be turned off when the battery pack needs a high power output.

16. The battery pack of claim 14, further comprising a temperature detection device, wherein the temperature detection device sends a temperature measurement to the controller, and the controller controls the second switching circuit to be turned on and controls the first switching circuit to be turned off when the temperature measurement is within a preset temperature range.

17. The battery pack of claim 16, wherein the preset temperature range is greater than or equal to minus 40° C. and less than or equal to 0° C.

18. The battery pack of claim 10, wherein the first battery cell is a one of first plurality of like battery cells, the second battery cell is a one of second plurality of like battery cells, and ones of the first plurality of battery cells and ones of the second plurality of battery cells are arranged alternately in the housing.

19. The battery pack of claim 10, wherein the second battery cell is a capacitor cell.

20. A battery pack for supplying electric power to a power tool, comprising:
a housing detachably mounted to the power tool;
a first battery cell disposed in the housing and supported by the housing, wherein the first battery cell has a first energy density;
a second battery cell disposed in the housing and supported by the housing, wherein the second battery cell has a second energy density, and a ratio of the second energy density to the first energy density is greater than or equal to 1.5; and
a terminal assembly electrically connected to the first battery cell and the second battery cell to transmit electric power from the first battery cell and the second battery cell to the power tool.
